(19) United States
(12) Patent Application Publication
(10) Pub. No.: US 2005/0036605 A1
(43) Pub. Date: Feb. 17, 2005

(54) Device housing responsive to an environmental stimulus

(76) Inventors: Robert John Mulligan, Sunrise, FL (US); Robert W. Pennisi, Boca Raton, FL (US); Steven Duane Pratt, Plantation, FL (US); Ronald James Kelley, Coral Springs, FL (US); Sivakumar Muthuswamy, Plantation, FL (US); Faye Nounou, Plantation, FL (US); Scott G. Potter, Coconut Creek, FL (US); Joseph G. Gillette, Margate, FL (US); Ying He, Plantation, FL (US); Bobby Dean Landreth, Ft. Lauderdale, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/943,393

(22) Filed: Sep. 17, 2004

Related U.S. Application Data
(62) Division of application No. 10/071,938, filed on Feb. 7, 2002.

(51) Int. Cl. H04M 1/00; H04M 9/00

(52) U.S. Cl. 379/433.01

(57) ABSTRACT

A housing (12) for use in a portable electronic device (10) includes an outer visible surface (14). The outer visible surface (14) is composed of an appearance changing substance responsive to an environmental stimulus.

### CROSS REFERENCE TO RELATED APPLICATIONS

This application is a divisional of pending U.S. application Ser. No. 10/071,938, filed Feb. 7, 2002, and assigned to Motorola, Inc.

### BACKGROUND OF THE INVENTION

1. Field of the Invention

This invention relates in general to device housings and in particular to device housings whose appearance is responsive to environmental stimuli.

2. Description of the Related Art

Housings for portable electronic devices are well known in the art. The role of a housing in a portable electronic device primarily includes covering, protecting and supporting the internal components encased within. The housing is adapted to provide a particular appearance by means of its molded contour, texture, or color. Typically, a conventional housing of a portable electronic device is standard in appearance and configuration. Minimal variation has conventionally been possible.

Furthermore, conventional portable electronic devices do not provide many options for a device user to alter the appearance of the portable electronic device once manufactured. Accessories such as device cases do provide some appearance differentiation, however, they tend to add size and weight to the portable device while providing a limited effect on the overall appearance.

Differentiating the appearance of individual portable electronic devices has become an important requirement for the customer, the manufacturer, and the distributor of such devices. Customers desire a unique appearance to satisfy their tastes and preferences. Customers further desire the ability to change the appearance of their portable electronic device for variety; and to match their moods, environment etc. Manufacturers desire a unique appearance to provide variety to their customers and to distinguish their products from competitor's products. Distributors desire a unique appearance to distinguish their product in the marketplace and to promote their brand name.

To provide product differentiation, manufacturers of portable electronic devices provide adhesive attached labels having different legends and appearances. Being adhesively attached, these labels offer a one-time option for the device user to choose a visual appearance for the exterior of the portable electronic device.

Some device manufacturers now offer interchangeable covers to provide customizable decorative ornaments for a portable electronic device. One example can be found in U.S. Pat. No. 5,745,566, issued Apr. 28, 1998 to Petrella et al. and titled “Portable Communication Device Having Removable Escutcheon Elements” which is assigned to the assignee of the present invention, and which is incorporated by reference herein. A benefit of these interchangeable covers is the additional protection they provide for the electronics contained within. A device user can easily change the device appearance with these customizable covers, typically available in an assortment of colors and patterns.

Similarly, some device manufacturers offer interchangeable faceplates accommodating differing sizes, shapes, and locations of buttons and displays of the portable electronic device. One example can be found in U.S. Pat. No. 5,884,772, issued Mar. 23, 1999 to Floyd et al. and titled “Electronic Device Having Multiple User Interface Configurations” which is assigned to the assignee of the present invention, and which is incorporated by reference herein. Utilization of such faceplates provides flexibility and manufacturing cost reductions, however, the appearance of the portable electronic device remains fixed for the device user.

One drawback of both interchangeable covers and interchangeable faceplates is that only one cover or faceplate and associated appearance applies. The device user physically removes one cover or faceplate and replaces it with another to provide a new appearance. Further, both interchangeable covers and interchangeable faceplates are inherently insecure in attachment to the portable electronic device, and are subject to loosening and detaching when jarred or dropped.

What is needed is a housing for a portable electronic device capable of providing a multiplicity of appearances with minimal user intervention and minimal additional components.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an illustration of a portable electronic device;

FIG. 2 is an exploded view of the portable electronic device of FIG. 1 in accordance with a preferred embodiment of the present invention;

FIGS. 3 to 5 are illustrations of various embodiments of the portable electronic device of FIG. 1 in accordance with a preferred embodiment of the present invention; and

FIG. 6 is a cross sectional view of a housing for use in the portable electronic device of FIGS. 1-5 in accordance with a preferred embodiment of the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

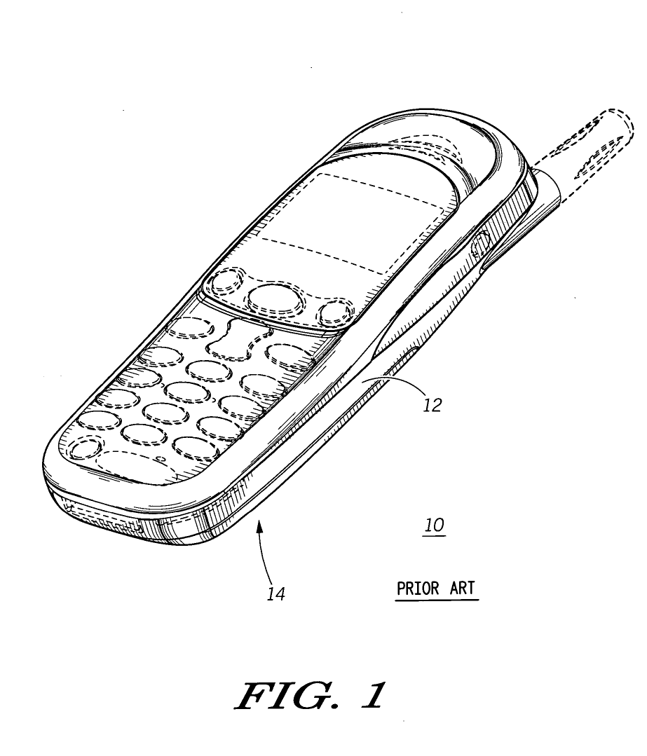

Referring to FIG. 1, a portable electronic device 10 is illustrated. The portable electronic device 10 includes a housing 12 having an outer visible surface 14. The housing 12 is preferably manufactured by a plastic injection molding technique as is well known in the art. By way of example, the preferred embodiment of the present invention is described in relation to a fixed housing such as the housing 12 of FIG. 1; however, it will be appreciated by one of ordinary skill in the art that the present invention is similarly applicable to a removable housing accessory such as the removable faceplate described in U.S. Pat. No. 5,884,772, issued Mar. 23, 1999 to Floyd et al. and titled “Electronic Device Having Multiple User Interface Configurations” which is assigned to the assignee of the present invention, and which is incorporated by reference herein. Similarly, the present invention is equally applicable to interchangeable covers for housings such as described in U.S. Pat. No. 5,745,566, issued Apr. 28, 1998 to Petrella et al. and titled “Portable Communication Device Having Removable Escutcheon Elements” which is assigned to the assignee of the present invention, and which is incorporated by reference herein.

Preferably, in accordance with the present invention, the outer visible surface is composed of an appearance changing substance. The appearance changing substance provides a means by which the physical environment of the portable electronic device 10 or external physical environment stimuli causes a change to the decorative appearance of the outer visible surface 14 of the housing 12. The appearance changing substance for example, can be a color changing substance, a pattern changing substance, an illumination producing substance, a shape changing substance, and a sensory producing substance or any combination therein. It will be appreciated by one of ordinary skill in the art that the appearance changing substance can be any of those substances mentioned herein or an equivalent.

When the appearance changing substance is a sensory producing substance, it can be a thermal producing substance, a vibration producing substance, and a haptic producing substance, or any combination therein. For example, the appearance changing substance can cause the housing 12 to interact with the muscles and tendons that give the human a sensation of a force being applied. Similarly, the housing 12 can interact with the nerve endings in the skin that indicate heat, pressure, and texture. It will be appreciated by one of ordinary skill in the art that the sensory producing substance can be any of those substances mentioned herein or an equivalent.

The appearance changing substance for example can utilize thermo-chromic pigments whereby heat results in changing colors. The thermal change can be due to a hot environment or the body heat of the device user. Specifically, the appearance changing substance can be composed of thermotropic liquid crystals. These liquid crystal molecules can change position, or twist, according to changes in temperature. This change in molecular structure affects the wavelengths of light that are absorbed or reflected by the liquid. For example, as the temperature increases, the liquid crystal molecules twist in one direction. This twist causes the liquid crystal substance to absorb more of the red and green portions of the visible light, and reflect the blue part. The result is that the housing 12 appears to be dark blue. When the temperature decreases, the molecules twist in the other direction, and reflect a different portion of the spectrum, causing the housing 12 to appear as a different color. It will be appreciated by one of ordinary skill in the art that, alternatively, the appearance changing substance can be a leuco dye rather than a liquid crystal, or an equivalent thermochromic technology.

As another example, the appearance changing substance can be ultraviolet light pigments causing a decorative and/or informative response to ultraviolet light. When the portable electronic device 10 is exposed to sunlight or a specific wavelength of ultraviolet light, the housing 12 can change appearance (color, shape, pattern, etc.). This could be for decorative purposes, for example, to change the color of the housing 12 when outdoors.

Each of the appearance changing substances, in accordance with a preferred embodiment of the present invention, is responsive to an environmental stimulus. The environmental stimulus, for example, can be an acoustic stimulus, a thermal stimulus, an electrical stimulus, an electromagnetic stimulus, a mechanical stimulus, an olfactory stimulus, or any combination thereof. It will be appreciated by one of ordinary skill in the art that the environmental stimulus can be any of those stimuli mentioned herein or an equivalent. Further, it will be appreciated by one of ordinary skill in the art that the environmental stimulus can be generated internally or externally to the portable electronic device 10. For example, environmental vibrations, noise, music, sunlight, body heat, etc. emanating from outside of the device would encounter the housing 12 of the portable electronic device 10 and result in changing its appearance in a decorative or informative manner.

An electrical stimulus can include a communication message transmitted to the portable electrical device 10 by a service provider as is well known in the art. Further, an electrical stimulus can included a user input to the portable electronic device 10 such as a device user pressing a button or series of buttons on the portable electronic device.

The environmental stimulus, in accordance with the present invention, can be automatically generated as a natural occurrence, can be manually generated, or any combination thereof. For example, the environmental stimulus can be initiated by the device user in response to the device user's desire for a change in the appearance of the portable electronic device 10.

In one embodiment, the sensitivity of the appearance changing substance can be adjusted or turned on or off. For example, the portable electronic device 10 can include manual sensitivity switches or software algorithms allow the device user to adjust the sensitivity of the appearance changing substance as desired. Similarly, the response of the appearance changing substance can be customized by the device user or selected from a plurality of responses. Further, in accordance with the present invention, the response of the appearance changing substance can be dynamically controlled either by a processor internal to the portable electronic device 10, a computer external to the portable electronic device 10, via receipt of a communication message either wirelessly or through a wired line, or any combination or equivalent therein. Dynamically controlling the response of the appearance changing substance provides a method for animations, messages, user customizable looks, and the like.

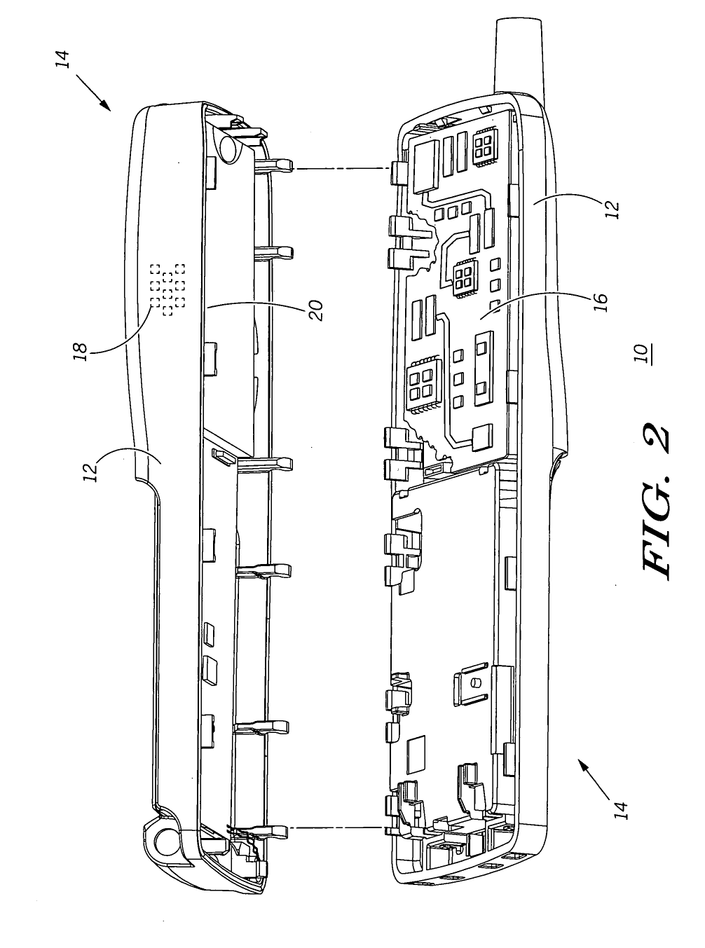

FIG. 2 is an exploded view of the portable electronic device 10 of FIG. 1 in accordance with a preferred embodiment of the present invention. As illustrated in FIG. 2, the portable electronic device 10 includes a plurality of internal components 16. The housing 12 encases the plurality of internal components 16, providing covering, protection and structural support. Preferably, and in accordance with the present invention, the plurality of internal components 16 generates an environmental stimulus in which the outer visible surface 14 of the housing 12 responds. For example, light from keypads or displays, vibrations from alerting mechanisms, or sound from speakers or transducers can generate environmental stimuli in which the appearance changing substance responds. It will be appreciated by one of ordinary skill in the art that the internal environmental stimulus can be any of those mentioned herein or an equivalent.

As illustrated in FIG. 2, the portable electronic device 10 further includes at least one resistive element 18. Preferably, the at least one resistive element 18 is energized to generate a thermal stimulus in which the outer visible surface 14 of the housing 12 responds. The appearance of the outer visible surface 14, for example, can be actively controlled by mating the at least one resistive element 18 to the housing 12 and selectively sending current by the plurality of internal components 16 to the at least one resistive element 18 to produce a thermal stimulus and generate a response by the appearance changing substance to change the appearance of the outer visible surface 14.

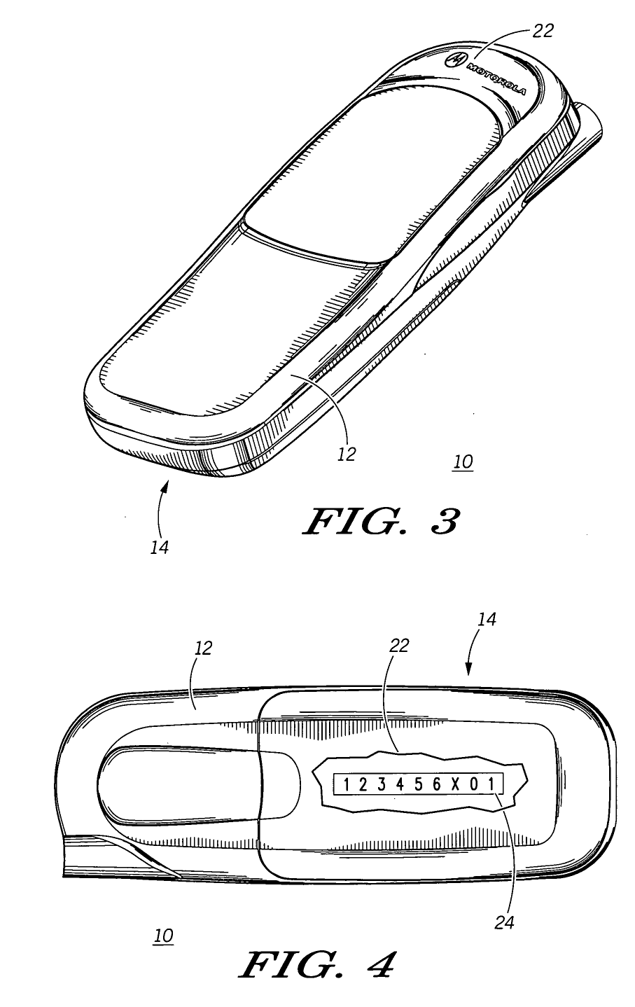

FIG. 3 is an illustration of one embodiment of the portable electronic device 10 of FIGS. 1 and 2 in accordance with a preferred embodiment of the present invention. As illustrated in FIG. 3, the outer visible surface 14 of the housing 12 includes a shape element 22.

As illustrated in FIG. 4, the shape element 22 can be an at least one identification information 24. For example, the at least one identification information 24 can be an identification data, an identification code, an identification pattern, an identification image, or any combination therein. It will be appreciated by one of ordinary skill in the art that the at least one identification information 24 can be any of the identification information mentioned herein or an equivalent. In accordance with the present invention, the identification information 24 can become visible, for example, when exposed to ultraviolet light for anti-counterfeiting and security measures.

As illustrated in FIG. 5, the shape element 22 can be an environment index gauge 26. For example, the environment index gauge 26 can be an ultraviolet light gauge, a temperature gauge, an acoustic gauge, or any combination therein. It will be appreciated by one of ordinary skill in the art that the environment index gauge 26 can be any of the gauges mentioned herein or an equivalent. The environment index gauge 26 provides potential environmental warnings to the device user to aid in protection of the device user from harmful environmental factors.

Referring to FIGS. 3 to 5, preferably, in accordance with the present invention, the shape element 22 is composed of an appearance changing substance. The appearance changing substance for example, can be a color changing substance, a pattern changing substance, an illumination producing substance, a shape changing substance, and a sensory producing substance or any combination therein. It will be appreciated by one of ordinary skill in the art that the appearance changing substance can be any of those substances mentioned herein or an equivalent.

The sensory producing substance can be a thermal producing substance, a vibration producing substance, and a haptic producing substance, or any combination therein. It will be appreciated by one of ordinary skill in the art that the sensory producing substance can be any of those substances mentioned herein or an equivalent.

Each of the appearance changing substances, in accordance with a preferred embodiment of the present invention, is responsive to an environmental stimulus. The environmental stimulus, for example, can be an acoustic stimulus, a thermal stimulus, an electrical stimulus, an electromagnetic stimulus, a mechanical stimulus, an olfactory stimulus, or any combination thereof. It will be appreciated by one of ordinary skill in the art that the environmental stimulus can be any of those substances mentioned herein or an equivalent. For example, the shape element 22 can be located near the surface of the housing 12 and act as a heat sink.

In one embodiment of the present invention, the shape element 22 with the appearance changing substance becomes visible in response to the environmental stimulus. It will be appreciated by one of ordinary skill in the art that alternatively the shape element 22 with the appearance changing substance becomes invisible in response to the environmental stimulus.

In one embodiment of the present invention, the plurality of internal components 16 generates an environmental stimulus in which the shape element 22 responds. Alternatively, the at least one resistive element 18 is energized to generate a thermal stimulus in which the shape element 22 of the outer visible surface 14 of the housing 12 responds.

As an example, the shape element 22 can be composed of a color changing ink. The color changing ink can change from one color to another, or alternatively can change from colored to clear. The color changing ink can be thermochromic, which change color in response to temperature fluctuations, or photochromic, which respond to variations in exposure to UV light (primarily sunlight). Both materials are reversible and will change colors over and over again with the appropriate exposure. Alternatively, the color changing ink can be hydrochromic, which changes color in response to water, or piezochromic, which changes color in response to pressure. Further, the color changing ink can be electrochromic, which changes color in response to the presence of a voltage.

In one embodiment, the shape element 22 is composed of electronic ink. The electronic ink is preferably comprised of a plurality of microcapsules, containing positively charged white particles and negatively charged black particles suspended in a clear ink. When a negative electric field is applied, the white particles move to the top of the microcapsule where they become visible to the user. This makes the surface appear white at that spot. At the same time, an opposite electric field pulls the black particles to the bottom of the microcapsules where they are hidden. By reversing the process, the black particles appear at the top of the microcapsule, making the surface appear dark at that spot.

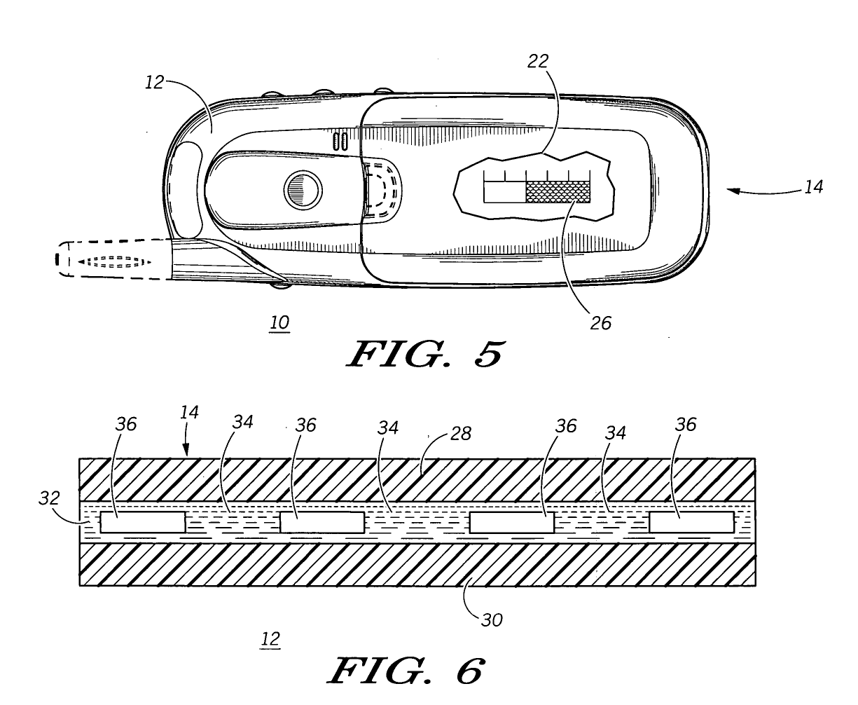

FIG. 6 is a cross sectional view of one embodiment of the housing 12 of the portable electronic device 10 of FIGS. 1-5 in accordance with the present invention. As illustrated, the housing 12 is composed of an outer layer 28, an inner layer 30, and an enclosed volume 32 arranged between the outer layer 28 and the inner layer 30. Preferably, the outer layer 28 preferably is composed of transparent materials to provide a visual path to the enclosed volume 32. The inner layer 30 can be either transparent or opaque in accordance with the present invention.

In one embodiment, the enclosed volume 32 comprises a plurality of fiber optics such as described in U.S. Pat. No. 5,087,906, issued Feb. 11, 1992 to Eaton et al and titled “Selective Call Receiver Having a Light Channel for Providing a Visual Alert” which is assigned to the assignee of the present invention, and which is incorporated by reference herein. For example, the enclosed volume can include a light channel such as a fiber optic cable. The light channel can comprise a variety of sizes and lengths without deviating from the intent of the invention. The light channel is illuminated using a light source positioned at one end of the light channel. The light source then can travel at a predetermined wavelength(s) to maximize diffusion of the light source.

The enclosed volume 32 preferably holds at least one fluid 34 and at least one decorative substance 36. In one embodiment, for example, the enclosed volume 32 contains multiple colored fluids. Alternatively, the enclosed volume can contain two or more immiscible liquids to create wave effects or any other liquid based dynamic decorating technique. The at least one decorative substance 36 can be, for example, a colored dye, a plurality of pearlescent particles, a plurality of light reflecting particles, a plurality of bubbles, at least one free floating solid shape, and at least one decorative substance comprises an immiscible liquid, or any combination therein. It will be appreciated by one of ordinary skill in the art that the at least one decorative substance 36 can be any of the substances mentioned herein or an equivalent.

The at least one decorative substance 36 in one embodiment is characterized by a decorative substance viscosity and the at least one fluid 34 is characterized by a fluid viscosity. Preferably, the decorative substance viscosity differs from the fluid viscosity. It will be appreciated by one of ordinary skill in the art that alternatively the decorative substance viscosity and the fluid viscosity can be substantially equivalent.

The elements of the enclosed volume, in accordance with the present invention, respond to one or more environmental stimuli. For example, in one embodiment of the present invention, the at least one decorative substance 36 moves in relation to the at least one fluid 34 in response to an environmental stimulus. The environmental stimulus can be, for example, an acoustic stimulus, a thermal stimulus, an ultraviolet light stimulus, an electromagnetic stimulus, a mechanical stimulus, or any combination thereof. It will be appreciated by one of ordinary skill in the art that the environmental stimulus can be any of the stimuli mentioned herein or an equivalent.

In one embodiment, the plurality of internal components 16 of the portable electronic device 10 generates the environmental stimulus. For example, heat, light, sound, vibration, electromagnetic fields, electrical voltage, or electrical current produced by the plurality of internal components 16 during product operation can cause special effects through the response of the elements of the enclosed volume.

For example, when the environmental stimulus is a light, the light interacts with the at least one decorative substance 36 to create a plurality of visual effects. Further, the light further can interact with the at least one fluid 34 to create a second plurality of visual effects.

Although the invention has been described in terms of preferred embodiments, it will be obvious to those skilled in the art that various alterations and modifications may be made without departing from the invention. Accordingly, it is intended that all such alterations and modifications be considered as within the spirit and scope of the invention as defined by the appended claims.

1. A housing for use in a portable electronic device comprising:
an outer layer, wherein the outer layer is composed of a transparent material;
an inner layer; and
an enclosed volume arranged between the outer layer and the inner layer, wherein the enclosed volume holds at least one fluid and at least one decorative substance.

2. A housing as recited in claim 1 wherein the at least one decorative substance is a combination of one or more substances selected from a group consisting of a colored dye, a plurality of light reflecting particles, a plurality of bubbles, at least one solid shape, and at least one decorative substance comprises an immiscible liquid.

3. A housing as recited in claim 1 wherein the at least one decorative substance is characterized by a decorative substance viscosity, wherein the at least one fluid is characterized by a fluid viscosity, and further wherein the decorative substance viscosity differs from the fluid viscosity.

4. A housing as recited in claim 1 wherein the at least one decorative substance moves in relation to the at least one fluid in response to an environmental stimulus.

5. A housing as recited in claim 4 wherein the environmental stimulus is a combination of one or more stimulus selected from a group consisting of an acoustic stimulus, a thermal stimulus, an electrical light stimulus, an electromagnetic stimulus, and a mechanical stimulus.

6. A housing as recited in claim 4 wherein the housing encases a plurality of internal components of the portable electronic device, and further wherein the plurality of internal components generates the environmental stimulus.

7. A housing as recited in claim 6, wherein the environmental stimulus is a light, and further wherein the light interacts with the at least one decorative substance to create a plurality of visual effects.

8. A housing as recited in claim 7 wherein the light further interacts with the at least one fluid to create a second plurality of visual effects.
